(19) United States
(12) Patent Application Publication
(10) Pub. No.: US 2009/0084932 A1
(43) Pub. Date: Apr. 2, 2009

(54) WIND TURBINE BLADE MOLDS

(75) Inventor: Jamie T. Livingston, Simpsonville, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/862,218

(22) Filed: Sep. 27, 2007

(51) Int. Cl. B28B 7/36

(52) U.S. Cl. 249/114.1; 164/6; 249/122

(57) ABSTRACT

A mold for a wind turbine blade includes a plurality of spaced-apart joists, each joist having an edge configuration generally corresponding to a form of the blade; and a flexible frame, supported by the edges of the joists, for shaping an exterior surface of the blade.

### BACKGROUND OF THE INVENTION

1. Technical Field

The subject matter described here generally relates to fluid reaction surfaces with vibration damping features, and, more particularly to molds, and methods of making molds, for use in manufacturing wind turbine blades.

2. Related Art

A wind turbine is a machine for converting the kinetic energy in wind into mechanical energy. If that mechanical energy is used directly by machinery, such as to pump water or to grind wheat, then the wind turbine may be referred to as a windmill. Similarly, if the mechanical energy is further transformed into electrical energy, then the turbine may be referred to as a wind generator or wind power plant.

Wind turbines use one or more airfoils in the form of a “blade” to generate lift and capture momentum from moving air that is them imparted to a rotor. Each blade is typically secured at its “root” end, and then “spans” radially “outboard” to a free, “tip” end. The front, or “leading edge,” of the blade connects the forward-most points of the blade that first contact the air. The rear, or “trailing edge,” of the blade is where airflow that has been separated by the leading edge rejoins after passing over the suction and pressure surfaces of the blade. A “chord line” connects the leading and trailing edges of the blade in the direction of the typical airflow across the blade.

Wind turbines are typically categorized according to the vertical or horizontal axis about which the blades rotate. One so-called horizontal-axis wind generator is schematically illustrated in FIG. 1. This particular configuration for a wind turbine 2 includes a tower 4 supporting a drive train 6 with a rotor 8 that is covered by a protective enclosure referred to as a “nacelle.” The blades 10 are arranged at one end of the rotor 8 outside the nacelle for driving a gearbox 12 connected to an electrical generator 14 at the other end of the drive train 6 inside the nacelle.

The blades 10 for modern wind generators can be over 80 meters long. Therefore, in order to minimize weight and maximize strength, the blades 10 are often formed as fiber-reinforced plastic shells in which a fiber material, such as fiberglass, carbon, or aramid is used to reinforce a polymer matrix, such as epoxy, vinylester or polyester thermosetting plastic resin. A hand lay-up technique is most-often used to apply the fabric components against a one-sided mold, after which resin is forced through the individual fiber mats using hand rollers. Once the fabric is saturated with resin, then the excess resin is removed with squeegees and the part is allowed to cure. Variations on this method include individually saturating each fiber mat before it is applied to the mold through the use of “pre-preg” material, and/or using applicators that saturate each layer before it is added to the mold. However, a wide variety of other techniques are also available for manufacturing such composites, including compression molding, vacuum molding, pultruding, filament winding, resin transfer molding.

The primary advantage of the hand lay-up technique is its suitability for fabricating very large, complex pails with relatively simple equipment and tooling. that are relatively less expensive than required by other manufacturing options. However, such large, complex parts nonetheless require a large and complex mold that can be difficult and costly to fabricate, especially for prototype components where the cost of the mold can not be allocated over a large number of fabricated components. Even with other, more capital-intensive wind turbine blade manufacturing processes, the cost of preparing the mold is a significant percentage of the overall cost of manufacturing the blades.

### BRIEF DESCRIPTION OF THE INVENTION

These and other aspects of such conventional approaches are addressed here by providing, in various embodiments, a mold for a wind turbine blade including a plurality of spaced-apart joists, each joist having an edge configuration generally corresponding to a form of the blade; and a flexible frame, supported by the edges of the joists, for shaping an exterior surface of the blade. Also provided is a method of making a mold for a wind turbine blade, including the steps of and/or for configuring an expanded metal frame to generally correspond to a form of the blade; applying a coating to the frame; and machining the coating to generally correspond with a shape of an exterior surface of the blade.

### BRIEF DESCRIPTION OF THE DRAWINGS

Various aspects of this technology invention will now be described with reference to the following figures (“FIGs.”) which are not necessarily drawn to scale, but use the same reference numerals to designate corresponding parts throughout each of the several views.

FIG. 1 is a schematic side view of a conventional wind turbine.

FIG. 2 is a partial, schematic orthographic view of a mold for making a wind turbine blade.

FIG. 3 is a exploded, partial side view of a method of making a mold for a wind turbine blade using the mold configuration shown in FIG. 2.

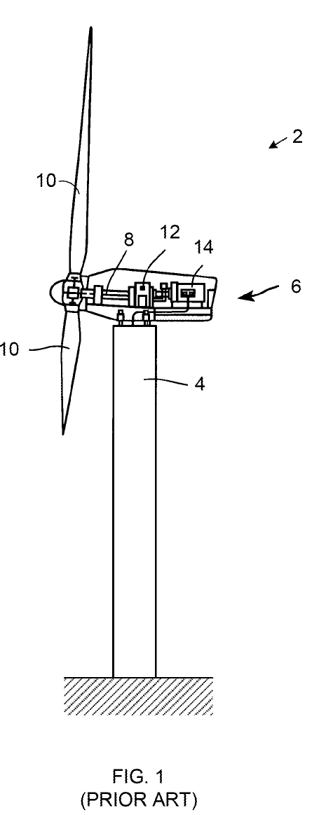

### DETAILED DESCRIPTION OF THE INVENTION

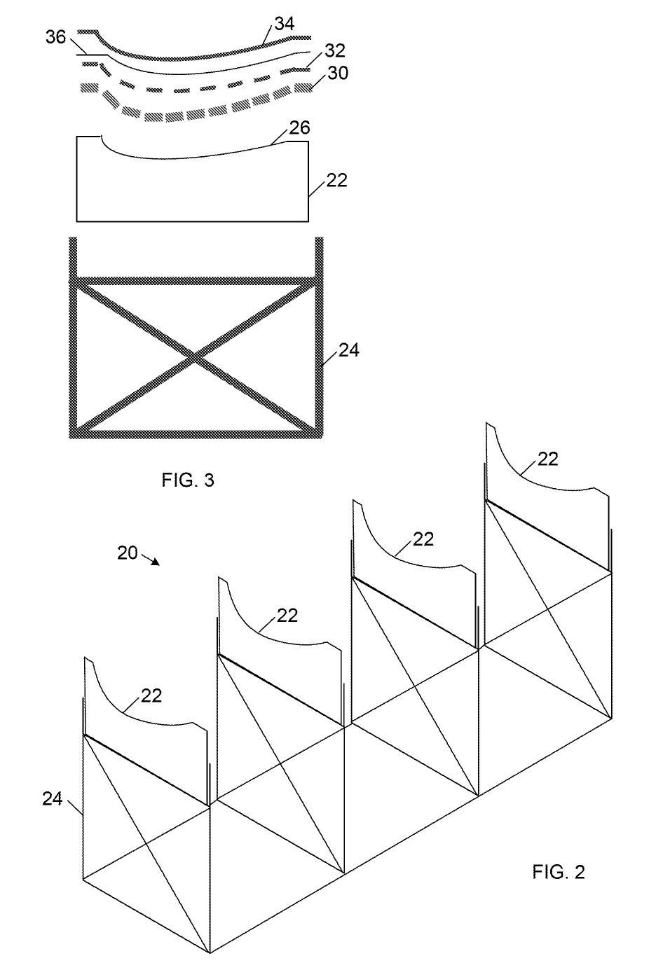

FIG. 2 schematically illustrates part of a mold for making, all or a portion of, a wind turbine blade 10. Some or all of the blade 10 may also be formed using various techniques, such as those described in co-pending, commonly-owned U.S. patent application Ser. Nos. 11/627,490 filed on Jan. 26, 2007 as “Preform Spar Cap for a Wind Turbine Rotor Blade,” and Ser. No. 11/311,053 filed on Dec. 19, 2005 as “A Modularly Constructed Rotorblade And Method For Construction.”

The mold 20 includes a plurality of joists 22 arranged on a support structure 24. The support structure 24 helps maintain the joists 22 with the appropriate spacing and height relative to each other. For example, the joists 22 may be 0.1 inch thick metal and/or composite plates that are spaced apart approximately twenty to thirty inches. However, a wide variety of other materials and/or dimensions may also be used, including plywood and/or glass reinforced plastic. For example, the joists 22 may be substantially wider in thickness and/or arranged closely adjacent to each other. Similarly, although the joists 22 in these illustrated examples are shown as being supported by a scaffolding-type support structure 24, other support structures and/or spacing mechanisms may also be used, including simply standing the joists 20 on the ground.

FIG. 3 illustrates is an exploded side view of one of the joists 22 and vertical portions of the support structure 24 in order to describe various embodiments of a method of malting the mold 20 for a wind turbine blade. As with FIG. 2, it must be kept in mind that the various steps described here are non-limiting in that they may be combined, including combined with other steps not discussed here, executed with other devices, including other devices not described here, and/or executed out of order from the various embodiments shown and discussed here, including being executed concurrently.

As best illustrated in FIG. 3, the edge 26 of each of the joists 22 has a configuration generally corresponding to the intended form of the external surface of the wind turbine blade 10. In particular, the curved portion of the edge 26 of the illustrated joists 22 corresponds to a chordwise portion of the external surface of the blade 10. However, any or all of the joists 22 may also be angled relative to the chord of the blade 10, including extending lengthwise in the direction of the span of the blade. Similarly, the joists 22 do not have to be arranged substantially perpendicular to the span of the blade 10 and or the ground. Consequently, each of the edges 26 of the joists 22 may have a slightly different shape that corresponds to a reverse of the external surface topography of the blade 10 at various positions along the blade 10. In order to provide precise shapes for the edges 26, each of the joists 22 may be cut with a numerically controlled saw, or other cutter, in order to achieve a shape as nears as possible to the desired external surface of the blade 10.

Once the joists 22 are cut and positioned with appropriate spacing and alignment, a flexible frame 30 is placed over and between each of the joists 20. For example, the flexible frame 30 may be formed from expanded metal plate typically used for decking, including mesh wire typically used for fencing, and/or plastic sheeting. The stiffness and corresponding thickness of the plate, wire, sheet, and/or other material for the frame 30 is preferably chosen to make it relatively easy to conform to the edges 26 of the joists 22 while still retaining the approximate curvature of the edges 26 between the joists 22. The use of additional joists 22 that are arranged closer together will allow the use of more flexible material that is easier to conform to the edges 24 of the joists 22. Conversely, fewer, further-spaced joist 20 will require a stronger, less flexible material for the frame 30 in order to better support the mold 20 between the longer spans separating joists 22. In either case, the use of a more or less flexible material allows the frame 30 to be configured with a shape corresponding to an exterior surface of the blade 10 using the edges 26 of the joists 22 as a template at each of the joist positions along the span of the blade.

If the flexible frame 30 can be configured with suitable tolerances relative to the intended dimensions of the blade 10, then any material that is used to form the blade, such as fiber reinforced resin, may be applied directly to the frame. However, it can be difficult to apply such materials while maintaining the shape of the frame 30, and to remove the cured blade 10 from the frame. Furthermore, leaving the frame 30 in the shell of the blade 10 adds weight and possible surface distortions to the blade. Consequently, one or more coatings may be arranged on a side of the frame 30 that is opposite from the joists 22.

In the illustrated embodiment, a first coating layer 32 is arranged on the frame 30, and an optional second coating layer 34 is arranged over the low density coating. For example, the first coating 32 may include rigid, semi-rigid, and/or flexible spray foam, such as a polyurethane foam and/or equivalent polyisocyanurate foam. Such low density, expanding materials for the first coating 32 will fill any openings in the frame 30, provide improved structural rigidity with little increase in weight, and are relatively easy to machine.

Once the first coating layer 32 is applied and cured, the surface of the layer 32 may be cut, ground, sanded, and/or otherwise formed to a shape that more-closely corresponds to the intended external shape of the blade 10. In particular, the layer 32 may be machined with computer-controlled equipment so as to provide an exact shape.

Since the first coating layer 32, and/or other materials with similarly suitable properties, may be relatively fragile, the second coating 34 may be applied as a protective layer of higher density material, such as filled or unfilled plastic resins, including polyester, vinylester, expoxy, and expoxy hybrids such as the DURATEC™ filler coatings available from Durall Plastics. In addition to enhancing durability of the mold 20, the optional second coating layer 34 also provides a smooth surface against which to form the blade 10. However, a variety of other materials may also be used for the first and second coating layers 32 and 34. The second coating layer 34 may also be polished waxed, and/or buffed in order to further improved the surface of the blade 10 to be formed with the mold 20.

An optional facesheet 36 may arranged between the first coating layer 32 and the second coating layer 34 in order to provide additional structural stability to the mold 20. For example, the facesheet 36 may be formed from composite material, such as a polymeric composite material, like fiber-reinforced plastics including glass-reinforced plastic. Once in place, the facesheet 36 may also be manually formed, directly machined, and/or machined with computer controlled equipment so as to provide an exact shape for the mold 20.

The technology described above provides various advantages over conventional technology. Forming a substantial portion of the mold 20 with the flexible frame 30 decreases the cost, weight, and set-up time associated with creating the mold. Consequently, the mold 20 is particularly useful for creating small numbers of prototype parts. In addition, the joists 24 are relatively small, lightweight, and easy to transport store as compared a conventional mold. The mold 20 is therefore relatively easy to setup and use a remote construction site in order to minimize the problems associated with transporting large wind turbine blade components.

It should be emphasized that the embodiments described above, and particularly any “preferred” embodiments, are merely examples of various implementations that have been set forth here to provide a clear understanding of various aspects of this technology. It will be possible to alter many of these embodiments without substantially departing from scope of protection defined solely by the proper construction of the following claims.

What is claimed is:

1. A mold for a wind turbine blade, comprising:
a plurality of spaced-apart joists, each joist having an edge configuration generally corresponding to a form of the blade; and
a flexible frame, supported by the edges of the joists, for shaping an exterior surface of the blade.

2. The mold recited in claim 1 wherein the flexible frame comprises expanded metal.

3. The mold recited in claim 2, further comprising at least one coating arranged on a side of the frame that is opposite from the joists.

4. The mold recited in claim 3, wherein the at least one coating comprises
a low density coating arranged on the frame; and
a high density coating arranged over the low density coating.

5. The mold recited in claim 4, wherein the low density coating comprises rigid spray foam.

6. The mold recited in claim 4, wherein the high density coating comprises polyester resin.

7. The mold recited in claim 6, wherein the high density coating comprises a plastic resin selected from the group consisting of polyester, vinylester, epoxy, and hybrids thereof.

8. The mold recited in claim 7, further comprising a polymeric composite facesheet arranged between the high density coating and the low density coating.

9. The mold recited in claim 1, wherein the joists are arranged chordwise relative to the blade.

10. The mold recited in claim 9 wherein the flexible frame comprises expanded metal.

11. A method of making a mold for a wind turbine blade, comprising the steps of:
configuring an expanded metal frame to generally correspond to a form of the blade;
applying a coating to the frame; and
machining the coating to generally correspond with a shape of an exterior surface of the blade.

12. The method recited in claim 11, wherein the coating comprises rigid spray foam.

13. The method of claim 12, further comprising the step of applying a protective coating over the machined rigid foam.

14. The method recited in claim 13, wherein the protective coating comprises a plastic resin selected from the group consisting of polyester, vinylester, epoxy, and hybrids thereof.

15. The method recited in claim 14, further comprising the step of arranging a polymeric composite facesheet between the machined foam and the polymeric resin protective coating.

16. A method of making a mold for a wind turbine blade, comprising:
a step for configuring an expanded metal frame to generally correspond to a form of the blade;
a step for applying a coating to the frame; and
a step for machining the coating to generally correspond with a shape of an exterior surface of the blade.

17. The method recited in claim 16, wherein the coating comprises rigid spray foam.

18. The method of claim 17, further comprising a step for applying a protective coating over the machined foam.

19. The method recited in claim 18, wherein the protective coating comprises a plastic resin selected from the group consisting of polyester, vinylester, epoxy, and hybrids thereof.

20. The method recited in claim 19, further comprising a step for arranging a polymeric composite facesheet between the machined foam and the protective coating.
